(19) United States
(12) Patent Application Publication
(10) Pub. No.: US 2010/0295675 A1
(43) Pub. Date: Nov. 25, 2010

(54) Location Device

(75) Inventor: Lindsay Lyon, Cottesloe (AU)

Correspondence Address: THE WEBB LAW FIRM, P.C., 700 KOPPERS BUILDING, 436 SEVENTH AVENUE, PITTSBURGH, PA, 15219, US

(73) Assignee: MOBILARM LIMITED, Applecross WA (AU)

(21) Appl. No.: 12/739,856

(22) PCT Filed: Sep. 17, 2008
(86) PCT No.: PCT/AU2008/001376

§ 371 Date: Aug. 16, 2010

(30) Foreign Application Priority Data
Oct. 26, 2007 (AU) 2007905890

(51) Int. Cl. G08B 1/08

(52) U.S. Cl. 340/539.13

(57) ABSTRACT

A location device includes a location detection and processing module, preferably a global positioning device for receiving satellite signals. Module outputs position data in the form of a digitally encoded signal to a control processor coupled to an activation device. The processor processes the signal and provides a signal to a voice synthesizer in a form the synthesizer can recognize and converts to a voice data signal stating the position in terms of latitude and longitude. The synthesizer sends that signal to a transmitter which transmits the signal as an over the air voice signal. The control processor may send the digitally encoded voice data to a transmitter or to a transmitter for direct transmission to a central authority. The device may include an activation module for activating the device response to a specific stimulus.

### FIELD OF THE INVENTION

This invention relates to a location device for providing the location of a person, animal or other object particularly in emergency or distress situations.

### BACKGROUND OF THE INVENTION

Location Devices are used in a number of environments. One such environment is a marine application in which the devices, usually in a form of a tag or pendent, is worn by a person onboard a boat. The device continually communicates with a monitoring system onboard the boat to determine the proximity of the device to the boat. If the device is detected this implies that the person is safely onboard the boat. However, if the device can no longer be detected this may be an indication that the person has fallen overboard. Thus, appropriate alarm can be given and a search for the person immediately commenced.

These devices may also provide the ability for self activation when they come into contact with the water so that an appropriate distress signal is given.

The onboard system includes a GPS system so that the location of the boat at the time the device was lost from the system can be given. This can be used to facilitate any additional search in the event that the person is not immediately found.

The disadvantage with the known devices used in marine applications is that whilst a GPS position can be logged, this is not necessarily the position of the person who, if not found immediately, may drift with current and therefore be well away from the boat and well outside the search area defined by the original GPS data provided when the device is lost to the system.

Another type of device to facilitate rescue of people or articles is a distress radio beacon, also known as a distress beacon, emergency beacon, or simply a beacon.

Generally when such a beacon is activated, it transmits a signal to a satellite which in tern relays the signal to a central search authority usually located on land. These beacons often transmit global positioning information on specific frequencies in electronically digitally coded format and thus are electronically translated into the latitude and longitude of the beacon. Persons involved in the recovery of the beacon, or beacon owner, must have access to specific equipment to decode the global positioning information, or be in contact with persons who have access to that equipment.

In the use of such beacons in a marine environment, such as a man overboard event, the emergency beacon often does not communicate to the crew of the vessel from which the event occurred, but rather communicates with a land based facility. In most cases the vessel will not have its own equipment to pick up or decipher the beacon's digital global positioning signal output. This process can result in significant time delays while the land base attempts to communicate to the vessel involved in the event.

Research has shown that the speed of recovering of persons in distress is a critical component in their survival and therefore the ability to involve as many persons as possible, and as quickly as possible in the locating and event recovery exercise will significantly improve the chances of survival.

### SUMMARY OF THE INVENTION

The present invention may be said to reside in a location device comprising:
a location detection processor for providing position data in relation to the location of the device;
a voice synthesiser for receiving the data and converting the data to a voice signal; and
a transmitter for receiving the voice data from the synthesiser and for transmitting the voice data as an over the air voice message.

Thus, because the position data is converted to voice data and transmitted by transmitter, a voice signal is transmitted from the device on any one or more of a number of standard channels for detection by surrounding vessels or the like. For example, in the case of a marine application the transmitter may transmit on the standard distress channel usually listened to by boat operators.

Therefore, the present invention enables any person with a tunable radio transmitter to pick up the voice signal from the device and hear the exact latitude and longitude location of the device in plain language voice message transmission. Therefore, the likelihood of the distress message being picked up by someone in the vicinity is greatly increased thereby also increasing the likelihood of quickly rescuing the person wearing the holding device. In one embodiment of the invention the location detection process or comprises a global positioning satellite device.

In one embodiment of the invention the device may also transmit the position data as an additional coded signal directly to a central authority or to the essential authority via one or more satellites.

The device may further comprise a control processor for activating the device and processing the position data for receipt by the voice synthesiser.

In one embodiment the device also includes a device activation module for activating the device in response to a specific stimulus, the module being for supplying a signal to the control processor to cause the control processor to activate the device.

In one embodiment this specific stimulus may be contact of the device with water, or the failure to receive a communication signal from a system network which determines the proximity of the device to the network, or rapid change in altitude.

### BRIEF DESCRIPTION OF THE DRAWING

An embodiment of the invention will be described, by way of example, with reference to the accompanying drawings in which;

FIG. 1 is a block diagram of one embodiment of the invention; and

FIG. 2 is a block diagram of a marine application of the embodiment of FIG. 1.

### DETAILED DESCRIPTION OF THE EMBODIMENT

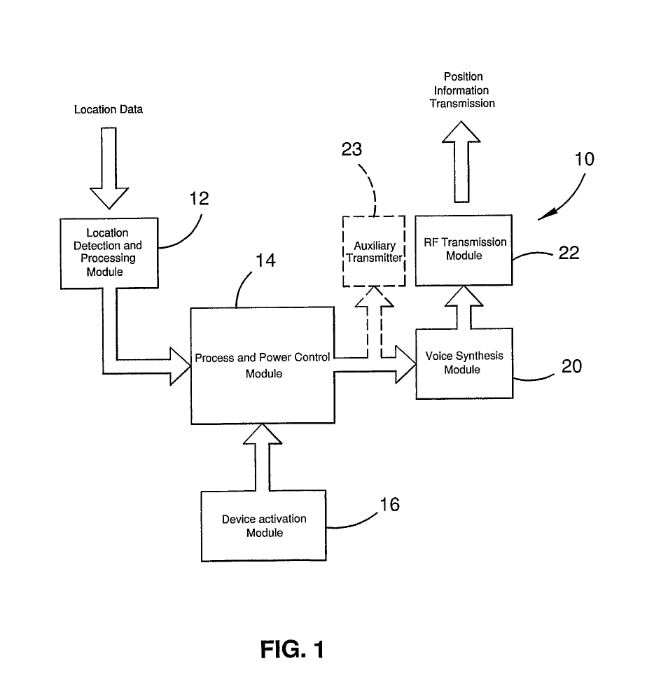

With reference to FIG. 1 an embodiment of the invention is disclosed which shows a location device 10 which may conveniently be in the form of a tag, pendent or other device which is worn or held by a person, or is otherwise is attached to an article for providing a distress signal. The device 10 comprises a location detection and processing module 12 which is preferably a global positioning satellite device for receiving signal from a plurality of satellites (not shown) so the position of the device can be determined. The module 12 outputs position data in the form of a digitally encoded signal to a control processor 14. The processor 14 also is coupled to an activation device 16 which provides a signal to the processor 14 to cause the processor 14 to activate the device 10. The processor 14 may provide further processing of the digital signal received form the processor 12 and to provide a signal to voice synthesiser 20 in a form the synthesiser can recognize and convert to a voice data signal stating the position of the device 10 in terms of latitude and longitude to a transmitter 22. The transmitter 22 then transmits the signal as a voice signal over the air for detection by a receiver (not shown).

Thus any receiver that receives this signal will hear the voice message stating the position of the device and therefore can quickly respond to give assistance. The voice message may also include a standard message referring to the emergency or distress condition.

The processor controller 14 may also provide the digitally encoded voice data to a transmitter apparatus in the form of a separate transmitter 23 for transmission to a satellite network to continue to relay the data to a central authority giving the position of the device. Alternatively, the transmitter 22 may receive and transmit the encoded voice data in addition to the over the air voice signal.

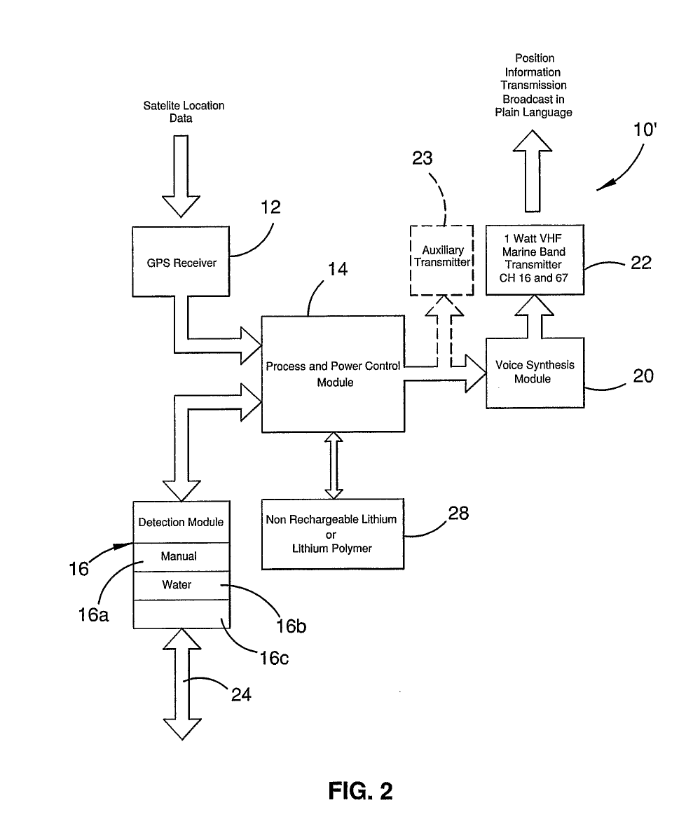

FIG. 2 is a block diagram illustrating a marine application of the invention. Like reference numerals indicate like parts to those previously described.

The satellite location data is received from satellites by the location detection processor 12 which in this embodiment is a global positioning satellite receiver and provides the digital signal representing the position of the device to the processor controller 14. The device 10 is typically worn by a person on board a boat to provide an emergency alert in the event that that person falls overboard. Typically such devices are worn by persons on charter boats, cruises or the like whether there exists the possibility of a person inadvertently falling overboard.

Activation module 16 in this embodiment communicates via transmitter/receiver 16c with a system network onboard the boat via a communication link 24. Typically the system network will output signals which, if the person wearing the device 10′ is onboard, will be received by the device 10′, prompting the device to acknowledge the signal by a return transmission to the network system which therefore indicates the person is safely onboard.

In the event that the person falls overboard, the system network onboard the boat no longer receives a signal back from the device 10′ and the system network can generate an alarm indicating that one of the devices 10′ worn by a passenger is not responding indicating that the person may have fallen overboard and appropriate search can immediately be commenced.

At the same time the device 10′ no longer receive the signal from the system network. The lack of signal is detected by the control processor 14 to causes activation of the device 10′ so that the position data provided by the GPS receiver 12 is processed and supplied to voice synthesiser 20 for conversion into voice data and for supply to transmitter 22 which can transmit the voice data as a voice signal on distress channels 16 and 67 which are usually listened to by all boat operators. Thus, any boat operator in the vicinity will hear the distress message and the position of the device 10′ as spoken message from a receiver onboard that boat, and can immediately respond to give assistance.

The control processor 14 may also supply the digitally coded voice data to a transmitter (which may be the transmitter 22 or the separate transmitter) so that data is transmitted to a satellite network for retransmission to a central authority which can also provide an emergency response.

The activation module 16 also can be activated manually by depression of a switch 16a or the like by the person wearing the device, or can be activated when the device 10′ comes into contact with the water as per water sensing module 16b to thereby provide a signal to the processor controller 14 to activate the device 10′.

The device 10 prime may be powered by a non rechargeable lithium or polymer battery 28.

It will be understood to persons skilled in the art of the invention that many modifications may be made without departing from the scope of the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A location device for use with a marine vessel, the location device arranged so as to be carried or worn by a person on a marine vessel, the location device comprising:
a location detection processor for providing position data in relation to the location of the device;
a voice synthesiser for receiving the position data and converting the position data to a voice signal;
a transmitter device for receiving the voice signal from the synthesiser and for transmitting an over the air voice message representative of the voice signal; and
a device activation module arranged to activate the location device and thereby cause the device to transmit the voice message when an indication is received by the device activation module that a person is not onboard the vessel.

2. The location device as claimed in claim 1, wherein the device is also operable to transmit the position data as an additional coded signal directly to a central authority.

3. The location device as claimed in claim 1, further comprising a control processor for activating the device and processing the position data for receipt by the voice synthesiser.

4. The location device as claimed in claim 3, wherein the control processor is operative to provide digitally encoded location data to the voice synthesiser.

5. The location device as claimed in claim 4, wherein the control processor is also operative to provide the digitally encoded location data to transmitter apparatus for transmission to a central authority.

6. The location device as claimed in claim 5, wherein the transmitter device comprises the transmitter apparatus.

7. The location device as claimed in claim 5, wherein the transmitter apparatus is separate to the transmitter device.

8. The location device as claimed in claim 1, wherein the device activation module is arranged to activate the location device when a manual switch on the location device is activated.

9. The location device as claimed in claim 1, wherein the device activation module is arranged to activate the location device in response to contact of the location device with water.

10. The location device as claimed in claim 1, wherein the device activation module is arranged to activate the location device when an expected signal is not received by the location device.

11. The location device as claimed in claim 1, wherein the device activation module is arranged to activate the location device when a change in altitude is detected by the location device.
